(19) United States
(12) Patent Application Publication
(10) Pub. No.: US 2022/0253040 A1
(43) Pub. Date: Aug. 11, 2022

(54) METHODS, SYSTEMS AND COMPUTER PROGRAM PRODUCTS FOR GENERATING AND IMPLEMENTING ENGINEERING DATA WITHIN PROCESS CONTROL SYSTEMS

(71) Applicant: Yokogawa Electric Corporation, Tokyo (JP)

(72) Inventors: Yi Ee LOKE, Singapore (SG); Maricel BACACAO, Singapore (SG); Archie Sambitan ORIDO, Singapore (SG); Max Jisong ZHANG, Singapore (SG); Daisuke YASUNAMI, Singapore (SG); Wilfred Woon Yew TEO, Singapore (SG); Hiroyuki NAKAMURA, Singapore (SG); Tadateru OHKAWARA, Singapore (SG); Keiko YUASA, Singapore (SG)

(73) Assignee: Yokogawa Electric Corporation, Tokyo (JP)

(21) Appl. No.: 17/172,759

(22) Filed: Feb. 10, 2021

(51) Int. Cl. G05B 19/418

(52) U.S. Cl. CPC G05B 19/418; G05B 2219/31368

(57) ABSTRACT

The invention enables generation of engineering data, for subsequent retrieval and implementation for a batch process. In an embodiment, the invention comprises (i) executing a processor implemented unit model editor, (ii) generating a unit model that includes data corresponding to a unit represented within a P&ID; (iiia) generating a control logic drawing corresponding to the unit represented within the P&ID, and (iii-b) generating a graphic drawing corresponding to the unit represented within the P&ID—both based on data parsed from the unit model, (iv) executing an operation sequence editor, (v) generating one or more operation sequences corresponding to the unit, and (vi) generating a wrapper object that includes the generated control logic drawing, the generated graphic drawing and the generated one or more operation sequences. Each of the control logic drawing, graphic drawing, and operation sequences may be implemented on formats that are different from the others.

### FIELD OF THE INVENTION

The invention relates to the field of industrial automation and process control systems. More specifically, the invention provides, methods, systems and computer program products that enable generation and storage of engineering data, for subsequent retrieval and implementation for a batch process.

### BACKGROUND OF THE INVENTION

Industrial environments implement control systems (for example, distributed process control systems) for running and controlling processes for manufacturing, conversion, or production. Control systems typically include one or more process controllers that are connected to one or more field devices. Field devices, may include valves, valve actuators, switches, and transmitters (e.g. temperature, pressure, level, and flow sensors) located within the industrial environment, and which are configured for physical control functions or process control functions. Examples of field device control functions include opening or closing valves, and measuring process and/or environmental parameters (e.g. temperature or pressure) for controlling one or more processes within the process plant or system.

At the other end, a process controller within the control system may be configured to receive signals generated by field devices, wherein the received signals convey information corresponding to process parameters measured by the field devices and/or other information concerning states of the field devices. The process controller may additionally execute a control application that implements one or more control modules for implementing process control decisions. Control modules within the process controller send control signals to field devices through communication lines or connections, to control operation of one or more of the field devices. Input-output (I/O) devices that are located as communication intermediaries between a process controller and one or more field devices enable data transfer and control instruction transfers between the process controller and the field devices, by converting electrical signals to digital values and by sending and receiving such signals over one or more communication protocols.

A control system within a process plant may include one or more process controllers, and each controller is connected to one or more field devices via I/O cards and/or I/O ports. The one or more controllers store control applications and implement control strategies for the control and operation of field devices. The control system may be configured to track or collect data related to the various plant assets or plant equipment, including, but not limited to, field devices, rotating equipment and key machineries. The control system retrievably stores device-related data and/or performance data for all devices or assets in a plant or group of plants, for the purposes of monitoring the statuses and health of plant assets and conducting maintenance work. Additionally, the control system may be configured to serve as a communication intermediary between a plant operator or an operator terminal on one hand, and one or more field devices on the other hand—for the purposes of enabling efficient configuration, commissioning, inspection, and maintenance of such field devices.

For the purposes of the present written description, it will be understood that references to a “field device” may include references to any of valves, valve actuators, switches, transmitters, smart transmitters, positioners, or other sensor devices that may be located within an industrial process environment, and that may be configured for physical or process control functions. Field devices may include “smart” field devices—i.e. devices that support digital communication protocols such as HART or Foundation Fieldbus communication protocols.

For the purposes of the present written description, references to “control system(s)” shall be understood as references to any control system(s) that may be implemented within a process control environment, an industrial plant, or an industrial environment, and shall include distributed control systems (DCS) and/or safety control systems (SCS).

For the purposes of the below written description, the term “physical device tag” shall mean a device name or device identifier that is associated with an actual field device. Ideally every field device located within an industrial environment or that is coupled with a control system within an industrial environment is provided with a unique physical device tag. Typically, each field device is provided with a local memory, and the physical device tag corresponding to such field device is retrievably stored within the local memory. When a field device is coupled with a control system, the control system can retrieve and read the physical device tag corresponding to the field device, and use such physical device tag as a unique identifier corresponding to the field device, for the purposes of field device operation, control or monitoring.

For the purposes of the below written description, the term “system tag” shall mean a name or identifier that is uniquely associated with a software function block or software control module, within a control system, and which software function block or software control module is configured to control, monitor or interface with a particular field device. Ideally every software function block of software control module that is configured to control, monitor or interface with a field device is provided with a unique system tag. System tags are used by the control system to implement, control and/or operate the corresponding software function block or software control module.

For the purposes of the below written description, the term “tag” by itself shall be understood to refer to either a physical device tag or a system tag.

When configuring and implementing processes within industrial environments, a piping and instrumentation diagram (P&ID) is used as a diagram to illustrate the piping of process flow together with installed equipment and instrumentation. Typically, one or more P&IDs are provided to engineers in the form of a print out, or in the form of a PDF-file or an image file. A P&ID typically includes standardized symbols and numbers for pipes, signal lines, instruments, and groups of instruments.

During the process control environment design process (e.g. an industrial plant design process) control engineers may design a process control system based on the P&ID drawing. The control engineer would read the P&ID, and extract engineering data therefrom. The engineering data may be used for configuring a batch process or one or more other processes within the process control environment.

FIG. 1 illustrates an exemplary P&ID 100. P&ID 100 shown in FIG. 1 illustrates processes involved in making and dispensing iced tea and includes representations of a teapot, two pitchers, water and steam inputs, and the corresponding piping, valve and control components involved in said processes.

Prior art processes for extracting and configuring engineering data from a P&ID for configuring one or more industrial processes, includes the steps of (i) defining and configuring function blocks that represent unit instruments and their constituent equipment and control modules, (ii) definition and configuration of operation sequences, and (iii) creating of a graphic drawing representing an overall batch process/industrial process.

For the purposes of this description, the term “unit” shall be understood (according to the standard ISA-88) as referring to a collection of process equipment, control equipment and the associated logic that carries out major processing activities. For example, major processing activities may include reaction, crystallization or mixing of materials.

For the purposes of this description, the term “operation sequence(s)” or “operation” shall be understood (according to the standard ISA-88) as referring to an ordered set of phases that cause a physical or chemical change to material.

For the purposes of this description, the term “graphic drawing(s)” shall be understood as referring to graphics or illustrations that are created to visualize the processes in an industrial plant—and which allow plant operators to both monitor and control the operations that are being implemented within an industrial environment.

The prior art processes for creation and configuration of the above described three categories of engineering data present multiple disadvantages, including that:
existing processes for extracting and configuring engineering data from P&IDs are manpower and time intensive, and requires extensive efforts to ensure data consistency (i.e. that the correct tag names are used consistently across the various different categories of engineering data).
tag names are used extensively when configuring engineering data for batch processes. Since naming conventions for tags can vary across different owners/operators, the final configured engineering data that results from the prior art processes are often not re-usable for other projects—since it is difficult to accurately correlate function blocks across the different categories of engineering data based solely on their tag names.

There is accordingly a need for solutions that (i) enable more intuitive extraction and configuration of engineering data from P&IDs, (ii) enable configuration of function blocks, operation sequences and graphic drawings within a single user interface, (iii) result in a reduction of complexity associated with configuration of engineering data across multiple different interface editors, and (iv) enable generation of reusable templates for engineering data, so as to achieve deployment of such templates across multiple different batch processes.

### SUMMARY

The invention provides, methods, systems and computer program products that enable generation and storage of engineering data, for subsequent retrieval and implementation for a batch process.

The invention provides a method for generating engineering data for process control within a process control system. The method comprises the steps of (i) initiating within an integrated software interface, execution of a processor implemented unit model editor, (ii) generating within the unit model editor, a unit model that includes data corresponding to a unit represented within a piping and instrumentation diagram (P&ID), (iii) implementing at a unit model convertor, the steps of (a) generating a control logic drawing representing engineering data corresponding to the unit represented within the P&ID, and (b) generating a graphic drawing representing engineering data corresponding to the unit represented within the P&ID—wherein the control logic drawing and the graphic drawing are generated based on data parsed by the unit model convertor from the generated unit model, (iv) initiating within the integrated interface, execution of an operation sequence editor, (v) generating through the operation sequence editor, one or more operation sequences corresponding to the unit, and (vi) generating a unit template that includes data corresponding to the generated control logic drawing, the generated graphic drawing and the generated one or more operation sequences, wherein each of the control logic drawing, graphic drawing, and operation sequences are generated based on a format that is different from the others.

The invention also provides a system for generating engineering data for process control within a process control system. The system comprises a memory and a processor. The processor may be configured for (i) initiating within an integrated software interface, execution of a processor implemented unit model editor, (ii) generating within the unit model editor, a unit model that includes data corresponding to a unit represented within a piping and instrumentation diagram (P&ID), implementing at a unit model convertor, the steps of (a) generating a control logic drawing representing engineering data corresponding to the unit represented within the P&ID, and (b) generating a graphic drawing representing engineering data corresponding to the unit represented within the P&ID—wherein the control logic drawing and the graphic drawing are generated based on data parsed by the unit model convertor from the generated unit model, (iii) initiating within the integrated interface, execution of an operation sequence editor, (iv) generating through the operation sequence editor, one or more operation sequences corresponding to the unit, and (v) generating a unit template that includes data corresponding to the generated control logic drawing, the generated graphic drawing and the generated one or more operation sequences, wherein each of the control logic drawing, graphic drawing, and operation sequences are generated based on a format that is different from the others.

The invention additionally provides a computer program product for generating engineering data for process control within a process control system. The computer program product comprises a non-transitory computer usable medium having a computer readable program code embodied therein, the computer readable program code comprising instructions for implementing within a processor based computing system, the steps of (i) initiating within an integrated software interface, execution of a processor implemented unit model editor, (ii) generating within the unit model editor, a unit model that includes data corresponding to a unit represented within a piping and instrumentation diagram (P&ID), (iii) implementing at a unit model convertor, the steps of (a) generating a control logic drawing representing engineering data corresponding to the unit represented within the P&ID, and (b) generating a graphic drawing representing engineering data corresponding to the unit represented within the P&ID—wherein the control logic drawing and the graphic drawing are generated based on data parsed by the unit model convertor from the generated unit model, (iv) initiating within the integrated interface, execution of an operation sequence editor, (v) generating through the operation sequence editor, one or more operation sequences corresponding to the unit, and (vi) generating a unit template that includes data corresponding to the generated control logic drawing, the generated graphic drawing and the generated one or more operation sequences, wherein each of the control logic drawing, graphic drawing, and operation sequences are generated based on a format that is different from the others.

### BRIEF DESCRIPTION OF THE ACCOMPANYING DRAWINGS

FIG. 1 illustrates an example of a P&ID as a source of engineering data.

FIG. 2 illustrates a process control environment that includes conventional builder interfaces for extracting and generating engineering data.

FIG. 3 illustrates a simplified depiction of a control logic drawing of a kind that may be generated based on a P&ID.

FIG. 4 illustrates a sequence library comprising a list of operation sequences defined for a unit within a P&ID.

FIG. 5 shows an exemplary ordered sequence of steps for an exemplary operation sequence.

FIG. 6 illustrates a graphic drawing of a kind that may be generated using a graphic builder of FIG. 2 based on a P&ID.

FIG. 7 illustrates an integrated software interface configured according to the teachings of the present invention.

FIG. 8 illustrates an exemplary data record of a kind that may be used for configuring and retrievably storing unit properties according to the teachings of the present invention.

FIG. 9 illustrates an exemplary data record of a kind that may be used for configuring and retrievably storing operation sequence properties according to the teachings of the present invention.

FIG. 10 illustrates a unit model editor of a kind that may be implemented within the integrated software interface of FIG. 8.

FIG. 11 illustrates assignment of placeholder tag names to instances of engineering data according to the teachings of the present invention.

FIG. 12 illustrates an operation sequence editor of a kind that may be implemented within the integrated software interface of FIG. 8.

FIG. 13 illustrates the various components involved in conversion of engineering data extracted from a P&ID into control logic drawings, graphic drawings and sequence libraries according to the teachings of the present invention.

FIG. 14 illustrates generation of a re-usable unit template according to the teachings of the present invention.

FIGS. 15 and 16 illustrate methods of generating and deploying engineering data according to the teachings of the present invention.

FIG. 17 illustrates an exemplary engineering data configuration system in accordance with the teachings of the present invention.

FIG. 18 illustrates an exemplary computer system according to which various embodiments of the present invention may be implemented.

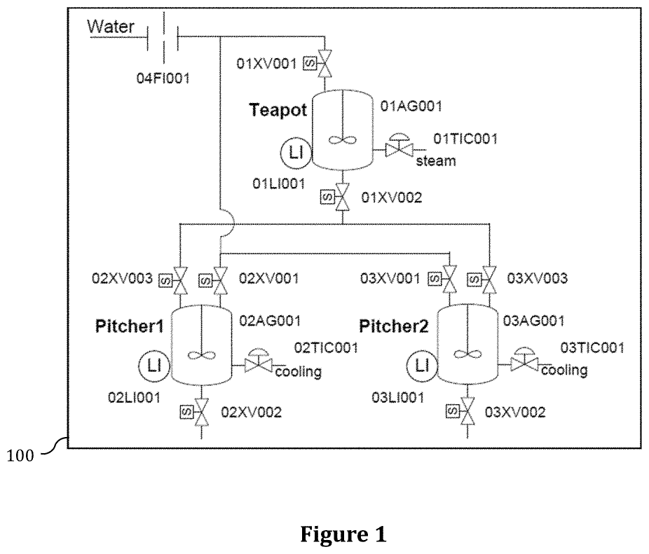

### DETAILED DESCRIPTION

The invention provides, methods, systems and computer program products that enable generation and storage of engineering data, for subsequent retrieval and implementation for a batch process.

For the purposes of explaining the present invention, processes for creation and configuration of function blocks, operation sequences and graphic drawings are described below.

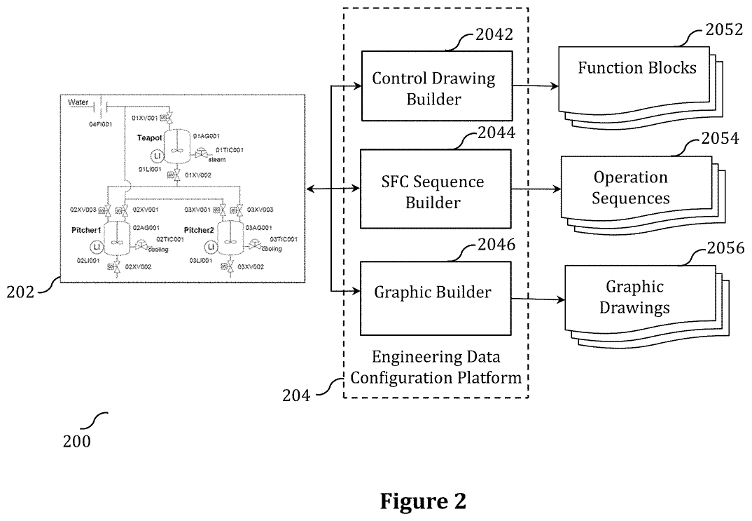

In the process control environment 200 of FIG. 2, a P&ID 202 is parsed such that
function blocks 2052 are identified and configured within control drawing builder 2042—wherein the process of identifying and configuring the function blocks includes defining a tag name(s) for each function block,
operation sequences 2054 are generated by a sequential function chart (SFC) sequence builder 2044—wherein the SFC sequence builder 2044 references the tag names that have been defined for each function block within the operation sequences, and
a graphic drawing 2056 is generated by graphic builder 2046—wherein the graphic builder 2046 may also reference the tag names that have been defined for each function block within the operation sequences.

Each of control drawing builder 2042, SFC sequence builder 2044 and graphic builder 2046 may comprise a distinct processor implemented software interface editor that is executable within engineering data configuration platform 204.

Further, in the illustration of FIG. 2, P&ID 202 serves as an input for configuring engineering data for the process control environment 200. Based on the P&ID 202, the three main units (teapot, pitcher 1 and pitcher 2) are identified and engineering data is generated for each unit. In the prior art processes, a control engineer may study P&ID 202 and may manually create the engineering data using each of the 3 distinct software interface editors 2042 to 2046 within the engineering data configuration platform 204.

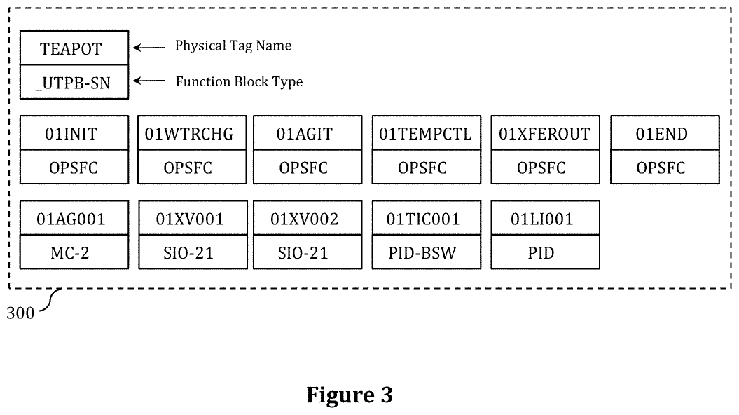

FIG. 3 illustrates a simplified depiction of a control logic drawing 300 of a kind that may be generated based on P&ID 202. The control logic drawing 300 contains function blocks 2052 that are created for the teapot unit by control drawing builder 2042. It will be noted that each function block is depicted as a data record having at least two distinct data elements—the first comprising a tag name assigned to the function block and the second comprising data representing a function block type associated with the function block.

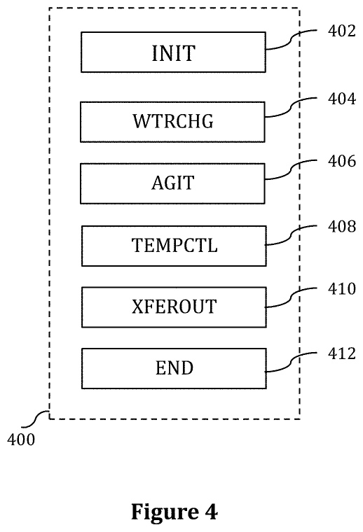

FIG. 4 illustrates a sequence library 400 comprising or consisting of a list of operation sequences 402 to 412 defined for the teapot unit of P&ID 202. The sequence libraries may be generated through the SFC sequence builder 2044 of FIG. 2. The list 400 comprises operation sequences for initialization (INIT 402), water charging (WTRCHG 404), agitating (AGIT 406), temperature control (TEMPCTL 408), transfer out (XFEROUT 410) and termination (END 412) that are represented within P&ID 202. Each operation sequence contains an ordered sequence of steps that results in a change (e.g. a physical or a chemical change or other state change) to material held, contained within or operated on by the relevant unit of the P&ID 202, and can be represented in a sequence flow chart.

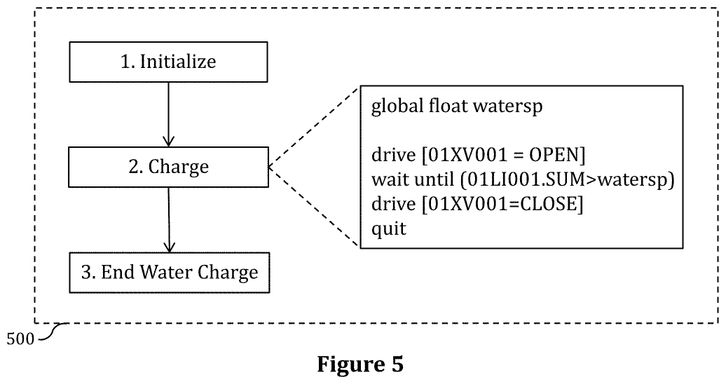

For the purposes of illustration, FIG. 5 shows an exemplary ordered sequence of steps for the water charging (WTRCHG 404) operation sequence of FIG. 4—which performs the act of charging the teapot unit with water. Software code (for example Sequence and Batch Oriented Language (SEBOL) code) is defined for each step within the sequence flow chart, and FIG. 4 illustrates an exemplary code snippet corresponding to the charging step within FIG. 5. As shown in FIG. 5, the software code may include references to tag names (e.g. 01XV001, 01LI001) of function blocks that are involved or operated upon for the purposes of implementing a specific step within the sequence flow chart.

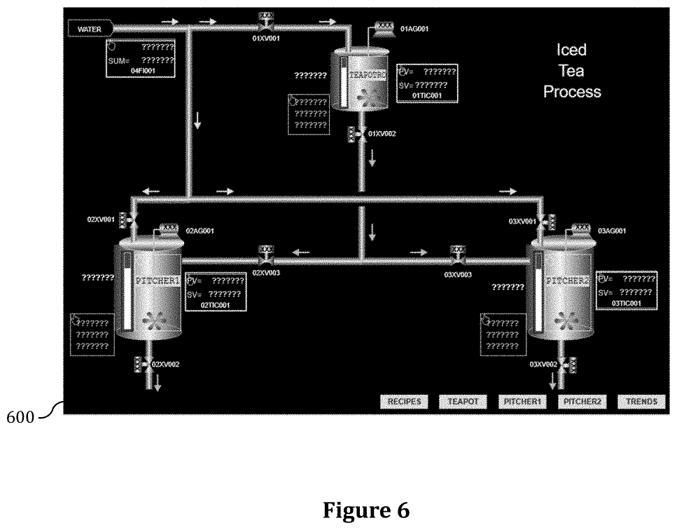

FIG. 6 illustrates a graphic drawing 600 of a kind that may be generated using the graphic builder 2046 of FIG. 2 based on P&ID 202. The graphic drawing(s) generated by graphic builder 2046 provides a visualization of an entire batch process, and enables an operator to operate and control the batch process. As shown in FIG. 6, the graphic drawing 600 may reference the tag names of function blocks that are included within said graphic drawing 600.

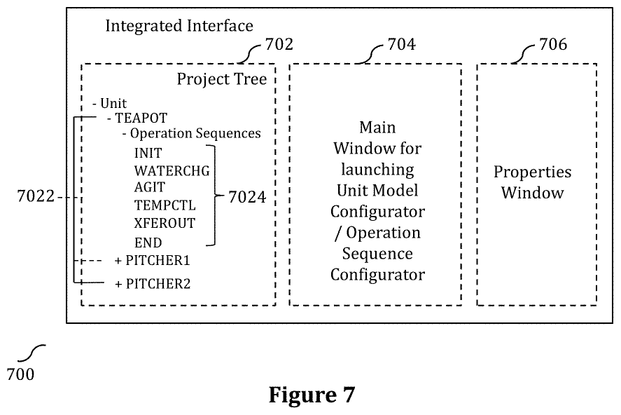

FIG. 7 illustrates an integrated software interface 700. Integrated software interface 700 is configured to enable generation of control logic drawings, graphic drawings and operation sequences within a single or unified software interface.

As shown in FIG. 7, integrated software interface 700 may comprise a plurality of windows. Window 702 may be configured to provide a tree structure display of project components. In the embodiment illustrated in FIG. 7, window 702 provides a collapsible tree structure wherein parent nodes in the structure represent individual units 7022 extracted from the P&ID, and sub-nodes in the structure represent individual operation sequences 7024 corresponding to each such unit.

Window 704 is configured to launch and display a unit model configurator, or an operation sequence configurator from within the integrated software interface—wherein each such configurator may be configured to generate output engineering data in a format or record type that is distinct from the other configurators.

Window 706 is configured to enable display and configuration of properties of individual engineering data that is selected or being operated on within windows 702 and 704.

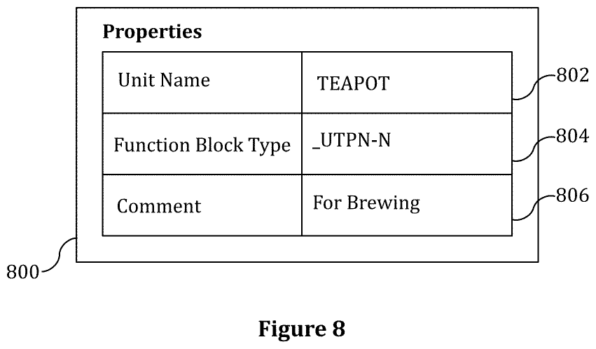

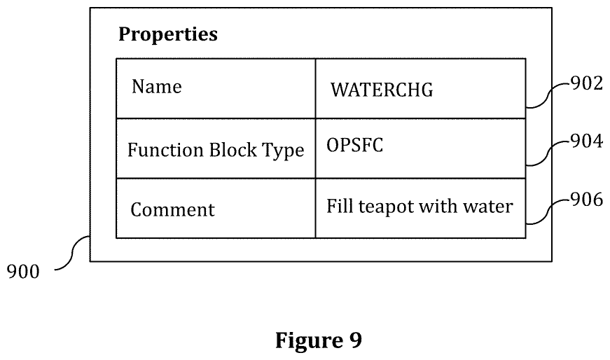

The integrated interface 700 of FIG. 7 is configured to enable units, and operation sequences that correspond to such units, to be created and managed centrally within a single interface. A control engineer may configure:
the properties of the unit (e.g. unit name, function block type etc.) within the integrated interface 700, and may generate a data record 800 (of a kind represented in FIG. 8) representing the configured properties 802 to 806 (e.g. unit name, function block type and any comments) of the unit, and
operation sequences (e.g. operation sequence name, function block type etc.) within the integrated interface 700, and may generate a data record 900 (of a kind represented in FIG. 9) representing the configured properties 902 to 906 (e.g. operation sequence name, function block type and any comments) of the operation sequence.

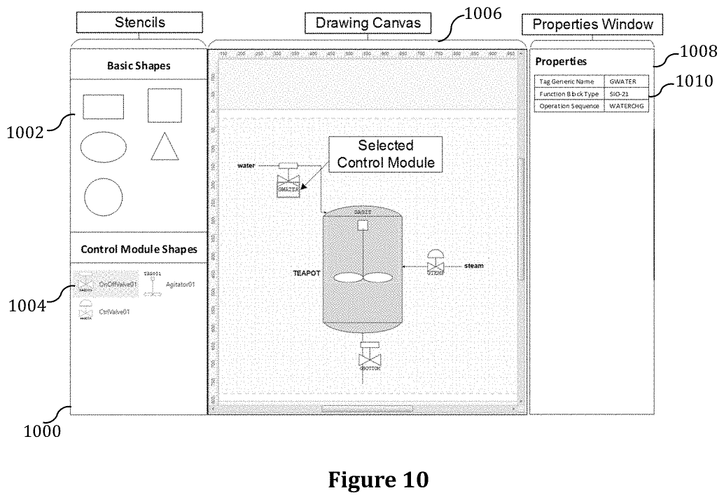

Integrated interface 700 is configured to enable each unit to be represented as a unit model. Each unit model may be configured within the unit model editor 1000 as illustrated in FIG. 10—and which may be launched within window 704 of integrated interface 700. Unit model editor 1000 provides a drawing canvas 1006 for a control engineer to create a visual drawing of a unit. Basic shapes (e.g. rectangle, ellipse, etc.) are provided for selection from within a library of predefined stencils/shapes 1002, and unit model and/or control module shapes are provided for selection from within a library of unit model and/or control module shapes 1004. These shapes aid a control engineer in convenient creation of a unit model within the unit model editor 1000. Each available or control module shape represents a type of physical equipment (e.g. valves, sensors, motors etc.).

Unit model editor 1000 additionally provides a window 1008 for viewing and configuring properties 1010 of the units that are being assigned to a unit model within the unit model editor 1000.

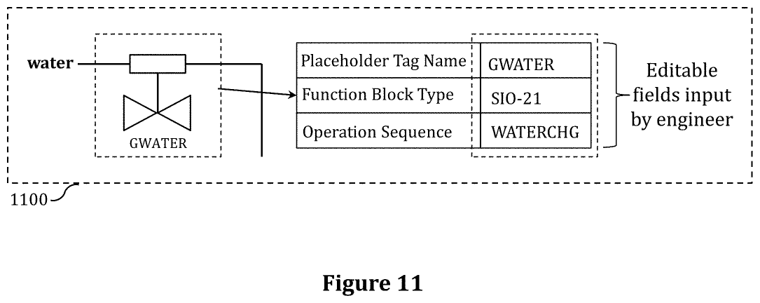

FIG. 11 illustrates assignment of placeholder tag names to instances of engineering data according to the teachings of the present invention. In particular, FIG. 11 shows the assignment of the placeholder tag name “GWATER” to a control module shape representing an ON/OFF valve. The function block type “SIO-21” is inputted by the user based on, for example, user knowledge, which is typically used to control an ON/OFF valve. Finally, the “WATERCHG” operation sequence is assigned to the control module shape. As illustrated in FIG. 11, when creating a unit model 1100, the unit model editor 1000 enables an operator to avoid specifying an actual tag name for one or more function blocks that are intended to be associated with each unit model and/or control module shape. Instead a control engineer may assign a “placeholder tag name” to one or more of each unit model and/or control module shape. The “placeholder tag name” functions as a placeholder for the actual tag name. This decouples each unit model and/or corresponding function blocks from the actual tag name and facilitates re-usability. In addition to the “placeholder tag name”, a control engineer is also able to configure other unit model properties and/or control module shape properties, which include a function block type, and also an operation sequence name (or other identifier associated with an operation sequence). This allows the control engineer to associate each unit module with its function block and corresponding operation sequence(s).

It would be understood that various items or instances of engineering data may be assigned to a unit or control module after a user has generated a unit or control module shape. For example, as shown in FIG. 11, when a user selects a generated unit or control module, a property table (or attribute table) may be displayed through integrated interface 700 (for example, within unit model editor 1000)—through which the user or control engineer may assign to the unit or control module, instances of engineering data as properties associated with the unit or control module. So for example, a user or control engineer may define/assign a “GWATER” placeholder tag name to the control module shape representing an ON/OFF valve (using the property table). The user or control engineer can also select the function block type “SIO-21” (for example, from a palette or menu of available function block types displayed within the integrated interface 700), which is typically used to control an ON/OFF valve using the same property table. Finally, the user can select an operation sequence name (or other identifier associated with an operation sequence) to the control model shape” through the integrated interface 700, using the same property table. Based on the teachings of FIG. 11, it would therefore be understood that interface editor 700 or components thereof may be configured to enable items or instances of engineering data to be assigned to a unit or control module after a user has generated a unit or control module—by virtue of assigning or specifying properties or attributes for such unit or control module.

The information containing the assignment of the placeholder tag name and function block type for each unit model (and the control modules in each unit model), or for that matter containing assignment of any other items or instances of engineering data, can be used as input to a converter that is configured for generating a control logic drawing based on the defined unit model (discussed in more detail below).

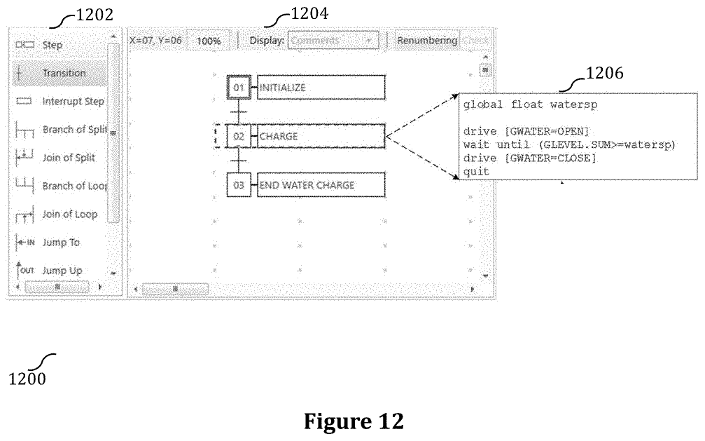

FIG. 12 illustrates an operation sequence editor 1200 of a kind that may be implemented within the integrated software interface of FIG. 8.

Operation sequence editor 1200 may be configured such that operation sequences that correspond to a specific unit or unit model may be generated within the operation sequence editor 1200. The editor 1200 may provide a drawing canvas 1204 for a control engineer to create an ordered sequence of steps to represent a sequence flow chart. The sequence of steps may be ordered by selecting directed connectors available from window 1202—wherein the directed connectors specify a control flow and may define how to proceed from one step to the next. A text editor 1206 is configured to enable one or more steps in the operation sequence to allow a control engineer to specify or create programming code (for example, SEBOL code) that is intended to be implemented at one or more specific steps in the operation sequences. As in the case of FIG. 11, operation sequence editor enables the control engineer to assign “placeholder tag name(s)” to the programming code. The placeholder tag name(s) used in a snippet or segment of programming code associated with an operating sequence for a unit model will be the same placeholder tag name(s) that have been assigned to the corresponding or relevant unit model or control module shape, when the unit model was created within the unit model editor 1000. This allows the control engineer to associate each operation sequence with its corresponding unit model and/or control module shape and it corresponding function block.

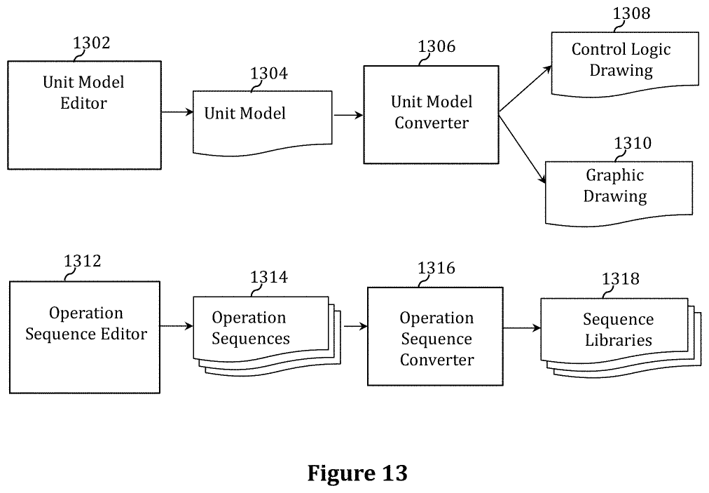

FIG. 13 illustrates the various components involved in conversion of engineering data extracted from a P&ID into control logic drawings, graphic drawings and sequence libraries according to the teachings of the present invention. As shown in FIG. 13, unit model editor 1302 is used to generate one or more unit models 1304 based on data represented within a P&ID. The generated unit model 1304 is then parsed and processed by a processor implemented unit model converter 1306—which generates (i) a control logic drawing 1308 based on the generated unit model(s) 1304 (and its assigned properties) and (ii) a graphic drawing 1310 based on the generated unit model(s) 1304 (and its assigned properties).

Operation sequence editor 1312 is used to generate one or more operation sequences 1314 based on data represented within a P&ID. Thereafter, the operation sequences 1314 that have been generated by operation sequence editor 1312 may be parsed and processed by a processor implemented operation sequence converter 1316—which generates one or more operation sequence libraries 1318 based on the generated operation sequences 1314. Despite the fact that all of control logic drawing 1308, graphic drawing 1310, and operation sequence library(ies) 1316 are generated by a control engineer within an integrated interface 700—each one is generated according to a different underlying format or standard, and/or each one is readable by a software program that is distinct from the others.

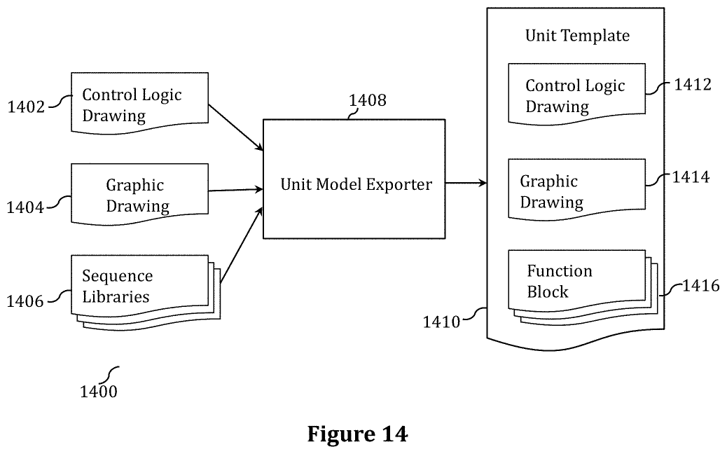

FIG. 14 illustrates generation of a re-usable unit template 1410 according to the teachings of the present invention. As shown in FIG. 14, each of the control logic drawing 1402, graphic drawing 1404 and sequence library(ies) 1406 that have been generated according to the teachings of FIG. 13 are parsed and processed by unit model exporter 1408—wherein the unit model exporter 1408 is configured to generate a unit template 1410 comprising a wrapper object configured to include therewithin all of the control logic drawing 1402, graphic drawing 1404 and sequence library(ies) 1406—wherein each of said the control logic drawing 1402, graphic drawing 1404 and sequence library(ies) 1406 has been generated according to a format or protocol that is different from the other two. Within unit template 1410, each set of correlated unit model(s) (or component(s) thereof), function block(s) and operation sequences that are associated with a common tag will be identified by an identical placeholder tag name—which enables all correlated members of such set to be identified and related, even after the control logic drawing 1402, graphic drawing 1404 and sequence library(ies) 1406 are unpacked or extracted from the unit template 1410.

When unit template 1410 is unpacked, and the unpacked control logic drawing 1402, graphic drawing 1404 and sequence library(ies) 1406 are sought to be deployed by a control engineer within a process control system, the placeholder tag names within each of said control logic drawing 1402, graphic drawing 1404 and sequence library(ies) 1406 may be substituted by tag names corresponding to the actual tags in relation to which the unpacked components are intended to be implemented or deployed. Use of the placeholder tag names and subsequent substitution of such placeholder tag names with actual tag names prior to deployment facilitates reusability of the control logic drawing 1402, graphic drawing 1404 and sequence library(ies) 1406.

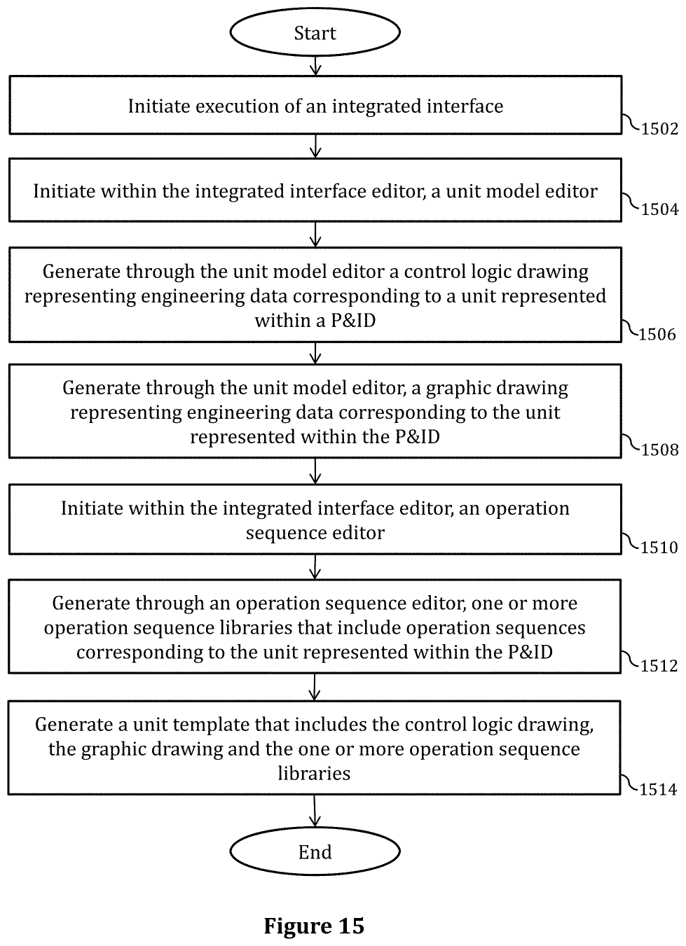

FIG. 15 illustrates a method of generating and configuring engineering data for a batch process, according to the teachings of the present invention.

Step 1502 comprises initiating execution of an integrated interface (for example integrated interface 700).

Step 1504 comprises initiating within the integrated interface 700 execution of a unit model editor (for example unit model editor 1000).

Step 1506 comprises generating through the unit model editor 1000 a control logic drawing representing engineering data corresponding to a unit represented within a P&ID.

At step 1508, the unit model editor 1000 is used to generate a graphic drawing representing engineering data corresponding to the unit represented within the P&ID.

Step 1510 comprises initiating within the integrated interface 700, an operation sequence editor (for example, operation sequence editor 1200).

Step 1512 comprises generating through the operation sequence editor 1200, one or more operation sequence libraries that include operation sequences corresponding to the unit represented within the P&ID.

Step 1512 comprises generating a unit template that includes the control logic drawing, the graphic drawing and the one or more operation sequence libraries. In an embodiment, each of control logic drawing 1308, graphic drawing 1310, and operation sequence library(ies) 1316 is generated according to a different underlying format or standard and/or each one is readable by a software program that is distinct from the others.

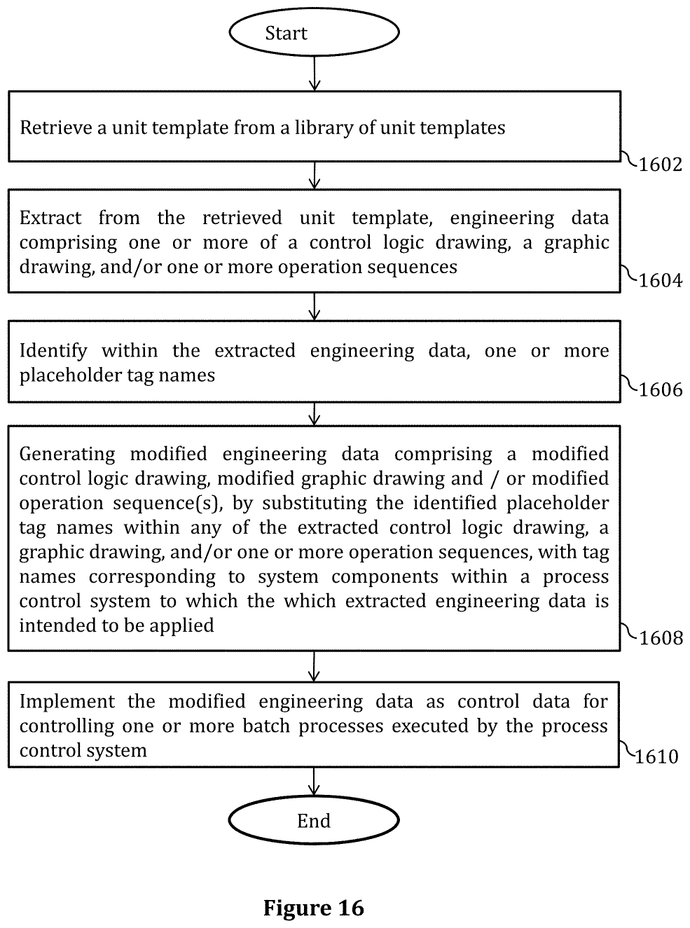

FIG. 16 illustrates a method of deploying engineering data according to the teachings of the present invention (for example engineering data that has been generated in accordance with the teachings of FIG. 15).

Step 1602 comprises retrieving a unit template from a library of unit templates. The unit template may be identified for retrieval by a control engineer based on a determined correlation or suitability of said unit model to one or more devices (control modules) or function blocks within a process control system in respect of which the unit template is intended to be deployed.

Step 1604 comprises extracting from the retrieved unit template, engineering data comprising one or more of a control logic drawing, a graphic drawing, and/or one or more operation sequences.

Step 1606 comprises identifying within the extracted engineering data, one or more placeholder tag names.

Step 1608 comprises generating modified engineering data comprising a modified control logic drawing, modified graphic drawing and/or modified operation sequence(s), by substituting the identified placeholder tag names within any of the extracted control logic drawing, a graphic drawing, and/or one or more operation sequences, with tag names corresponding to system components within a process control system to which the which extracted engineering data is intended to be applied.

Step 1610 comprises implementing the modified engineering data as control data for controlling one or more processes or batch processes executed by the process control system.

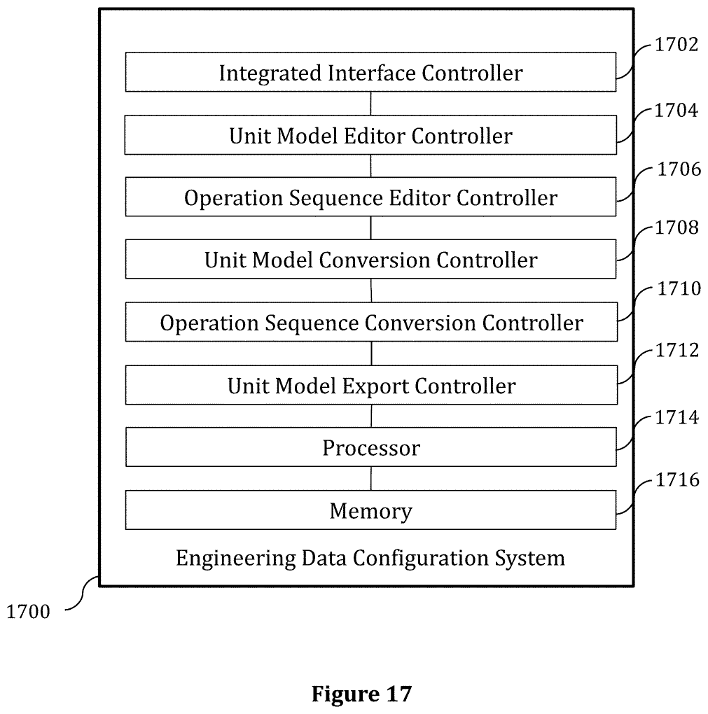

FIG. 17 illustrates an exemplary engineering data configuration system 1700 configured in accordance with the teachings of the present invention.

The engineering data configuration system 1700 comprises (i) an integrated interface controller 1702, (ii) a unit model editor controller 1704, (iii) an operation sequence editor controller 1706, (iii) a unit model conversion controller 1708, (iv) an operation sequence conversion controller 1710, (v) a unit model export controller 1712, (vi) a processor 1714, and (vii) a memory 1716.

Integrated interface controller 1702 is a processor implemented controller and may be configured to render and enable the above discussed functionality of integrated interface controller 700.

Unit model editor controller 1704 is a processor implemented controller and may be configured to render and enable the above discussed functionality of unit model editor 1000.

Operation sequence editor controller 1706 is a processor implemented controller and may be configured to render and enable the above discussed functionality of operation sequence editor 1200.

Unit model conversion controller 1708 is a processor implemented controller configured to implement and enable the above discussed functionality of unit model converter 1306.

Operation sequence conversion controller 1710 is a processor implemented controller configured to implement and enable the above discussed functionality of operation sequence convertor 1316.

Unit model export controller 1712 is a processor implemented controller configured to implement and enable the above discussed functionality of unit model exported 1408.

### Exemplary Embodiments

The invention provides a method for generating engineering data for process control within a process control system. The method comprises the steps of (i) initiating within an integrated software interface, execution of a processor implemented unit model editor, (ii) generating within the unit model editor, a unit model that includes data corresponding to a unit represented within a piping and instrumentation diagram (P&ID), (iii) implementing at a unit model convertor, the steps of (a) generating a control logic drawing representing engineering data corresponding to the unit represented within the P&ID, and (b) generating a graphic drawing representing engineering data corresponding to the unit represented within the P&ID—wherein the control logic drawing and the graphic drawing are generated based on data parsed by the unit model convertor from the generated unit model, (iv) initiating within the integrated interface, execution of an operation sequence editor, (v) generating through the operation sequence editor, one or more operation sequences corresponding to the unit, and (vi) generating a unit template that includes data corresponding to the generated control logic drawing, the generated graphic drawing and the generated one or more operation sequences, wherein each of the control logic drawing, graphic drawing, and operation sequences are generated based on a format that is different from the others.

In an embodiment of the method, the step of generating the control logic drawing, the graphic drawing or the one or more operation sequences includes assigning a placeholder tag to at least one unit model, or control module shape, or function block, software code segment therewithin.

In a more specific embodiment, further comprises implementing the generated engineering data within the process control system, wherein implementing the generated engineering data comprises the steps of (i) retrieving the generated unit template from a library, (ii) extracting from the retrieved unit template, engineering data comprising one or more of a control logic drawing, a graphic drawing, and one or more operation sequences, (iii) identifying within the extracted engineering data, one or more placeholder tag names, (iv) generating modified engineering data comprising any of a modified control logic drawing, a modified graphic drawings and one or more modified operation sequences, wherein generating the modified engineering data comprising substituting the one or more placeholder name tags with tag names corresponding to process control system components to which the extracted engineering data is intended to be applied, and (v) implementing the modified engineering data as control data for one or more processes executed by the process control system.

The method may include an embodiment wherein the unit template comprises a wrapper object, and said wrapper object is identified for retrieval based on identification of one or more unit models included within the control logic drawing, graphic drawing or sequence libraries within the wrapper object.

In a particular embodiment, the method may comprise identifying within the extracted engineering data, one or more placeholder tag names, wherein the unit template is further identified for retrieval based on a determined correlation of said unit to one or more devices or function blocks within the process control system.

The invention also provides a system for generating engineering data for process control within a process control system. The system comprises a memory and a processor. The processor may be configured for (i) initiating within an integrated software interface, execution of a processor implemented unit model editor, (ii) generating within the unit model editor, a unit model that includes data corresponding to a unit represented within a piping and instrumentation diagram (P&ID), (iii) implementing at a unit model convertor, the steps of (a) generating a control logic drawing representing engineering data corresponding to the unit represented within the P&ID, and (b) generating a graphic drawing representing engineering data corresponding to the unit represented within the P&ID—wherein the control logic drawing and the graphic drawing are generated based on data parsed by the unit model convertor from the generated unit model, (iv) initiating within the integrated interface, execution of an operation sequence editor, (v) generating through the operation sequence editor, one or more operation sequences corresponding to the unit, and (vi) generating a unit template that includes data corresponding to the generated control logic drawing, the generated graphic drawing and the generated one or more operation sequences, wherein each of the control logic drawing, graphic drawing, and operation sequences are generated based on a format that is different from the others.

The system may be configured such that generating the control logic drawing, the graphic drawing or the one or more operation sequences includes assigning a placeholder tag to at least one unit model, or control module shape, or function block, software code segment therewithin.

In a particular embodiment, the system may be configured for implementing the generated engineering data within the process control system, wherein implementing the generated engineering data comprises (i) retrieving the generated unit template from a library, (ii) extracting from the retrieved unit template, engineering data comprising one or more of a control logic drawing, a graphic drawing, and one or more operation sequences, (iii) identifying within the extracted engineering data, one or more placeholder tag names, (iv) generating modified engineering data comprising any of a modified control logic drawing, a modified graphic drawings and one or more modified operation sequences, wherein generating the modified engineering data comprising substituting the one or more placeholder name tags with tag names corresponding to process control system components to which the extracted engineering data is intended to be applied, and (v) implementing the modified engineering data as control data for one or more processes executed by the process control system.

In an embodiment, the system may be configured such that the unit template comprises a wrapper object, and said wrapper object is identified for retrieval based on identification of one or more unit models included within the control logic drawing, graphic drawing or sequence libraries within the wrapper object.

In a further embodiment, the system may be configured for identifying within the extracted engineering data, one or more placeholder tag names, wherein the unit template is further identified for retrieval based on a determined correlation of said unit to one or more devices or function blocks within the process control system.

The invention additionally provides a computer program product for generating engineering data for process control within a process control system. The computer program product comprises a non-transitory computer usable medium having a computer readable program code embodied therein, the computer readable program code comprising instructions for implementing within a processor based computing system, the steps of (i) initiating within an integrated software interface, execution of a processor implemented unit model editor, (ii) generating within the unit model editor, a unit model that includes data corresponding to a unit represented within a piping and instrumentation diagram (P&ID), (iii) implementing at a unit model convertor, the steps of (a) generating a control logic drawing representing engineering data corresponding to the unit represented within the P&ID, and (b) generating a graphic drawing representing engineering data corresponding to the unit represented within the P&ID—wherein the control logic drawing and the graphic drawing are generated based on data parsed by the unit model convertor from the generated unit model, (iv) initiating within the integrated interface, execution of an operation sequence editor, (v) generating through the operation sequence editor, one or more operation sequences corresponding to the unit, and (vi) generating a unit template that includes data corresponding to the generated control logic drawing, the generated graphic drawing and the generated one or more operation sequences, wherein each of the control logic drawing, graphic drawing, and operation sequences are generated based on a format that is different from the others.

In an embodiment of computer program product, the step of generating the control logic drawing, the graphic drawing or the one or more operation sequences includes assigning a placeholder tag to at least one unit model, or control module shape, or function block, software code segment therewithin.

In a further embodiment, the computer program product comprises instructions for implementing the generated engineering data within the process control system, wherein implementing the generated engineering data comprises the steps of (i) retrieving the generated unit template from a library, (ii) extracting from the retrieved unit template, engineering data comprising one or more of a control logic drawing, a graphic drawing, and one or more operation sequences, (iii) identifying within the extracted engineering data, one or more placeholder tag names, (iv) generating modified engineering data comprising any of a modified control logic drawing, a modified graphic drawings and one or more modified operation sequences, wherein generating the modified engineering data comprising substituting the one or more placeholder name tags with tag names corresponding to process control system components to which the extracted engineering data is intended to be applied, and (v) implementing the modified engineering data as control data for one or more processes executed by the process control system.

In another embodiment of the computer program product, the unit template comprises a wrapper object, and said wrapper object is identified for retrieval based on identification of one or more units models included represented within the control logic drawing, graphic drawing or sequence libraries within the wrapper object.

In a specific embodiment, the computer program product includes instructions for identifying within the extracted engineering data, one or more placeholder tag names, wherein the unit template is further identified for retrieval based on a determined correlation of said unit to one or more devices or function blocks within the process control system.

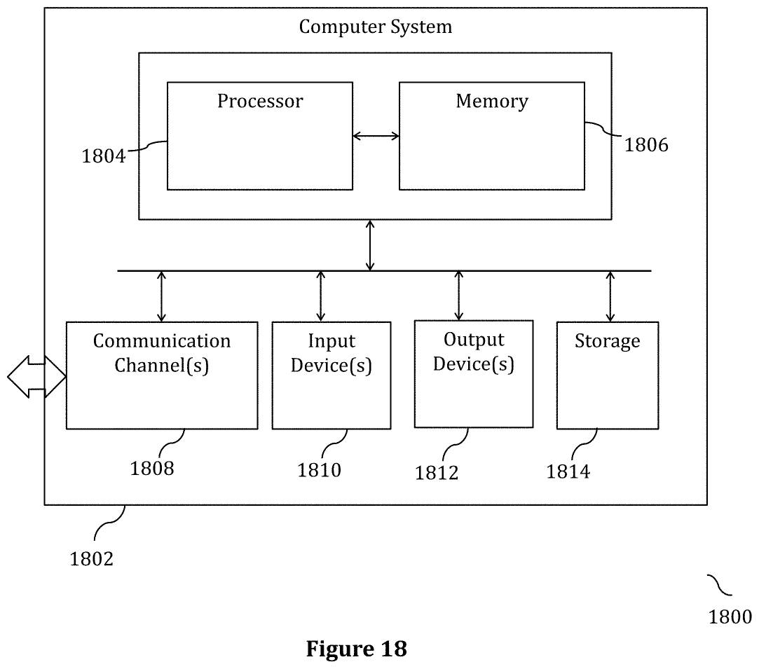

FIG. 18 illustrates an exemplary system 1800 according to which various embodiments of the present invention may be implemented.

System 1800 includes computer system 1802 which in turn comprises one or more processors 1804 and at least one memory 1806. Processor 1804 is configured to execute program instructions—and may be a real processor or a virtual processor. It will be understood that computer system 1802 does not suggest any limitation as to scope of use or functionality of described embodiments. The computer system 1802 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 1802 in accordance with the present invention may include one or more servers, desktops, laptops, tablets, smart phones, mobile phones, mobile communication devices, tablets, phablets and personal digital assistants. In an embodiment of the present invention, the memory 1806 may store software for implementing various embodiments of the present invention. The computer system 1802 may have additional components. For example, the computer system 1802 may include one or more communication channels 1808, one or more input devices 1810, one or more output devices 1812, and storage 1814. An interconnection mechanism (not shown) such as a bus, controller, or network, interconnects the components of the computer system 1802. In various embodiments of the present invention, operating system software (not shown) provides an operating environment for various softwares executing in the computer system 1802 using a processor 1804, and manages different functionalities of the components of the computer system 1802.

The communication channel(s) 1808 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 1810 may include, but is not limited to, a touch screen, a keyboard, mouse, pen, joystick, trackball, a voice device, a scanning device, or any another device that is capable of providing input to the computer system 1802. In an embodiment of the present invention, the input device(s) 1810 may be a sound card or similar device that accepts audio input in analog or digital form. The output device(s) 1812 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 1802.

The storage 1814 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1802. In various embodiments of the present invention, the storage 1814 may contain program instructions for implementing any of the described embodiments.

In an embodiment of the present invention, the computer system 1802 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1802. The method described herein is typically implemented as a computer program product, comprising a set of program instructions that is executed by the computer system 1802 or any other similar device. The set of program instructions may be a series of computer readable codes stored on a tangible medium, such as a computer readable storage medium (storage 1814), for example, diskette, CD-ROM, ROM, flash drives or hard disk, or transmittable to the computer system 1802, via a modem or other interface device, over either a tangible medium, including but not limited to optical or analogue communications channel(s) 1808. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it would be apparent that the present invention offers significant advantages. In particular, the invention enables configuration of function blocks, operation sequences and graphic drawings within an integrated editor. As a result, existing processes for extracting and configuring engineering data from P&IDs is manpower and time efficient, and optimizes the expenditure of effort towards ensure data consistency (i.e. that the correct tag names are used consistently across the various different categories of engineering data). Additionally, by providing for placeholder tag names during generation of engineering data and creation of unit templates/wrapper objects for such engineering data, and for subsequent substitution of placeholder tag names within such engineering data prior to deployment within a process control system, the invention facilitates re-usability of engineering data across process control systems and across industrial plants and projects.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

1. A method for generating engineering data for process control within a process control system, the method comprising:
initiating within an integrated software interface, execution of a processor implemented unit model editor;
generating within the unit model editor, a unit model that includes data corresponding to a unit represented within a piping and instrumentation diagram (P&ID);
implementing at a unit model convertor, the steps of:
generating a control logic drawing representing engineering data corresponding to the unit represented within the P&ID; and
generating a graphic drawing representing engineering data corresponding to the unit represented within the P&ID;
wherein the control logic drawing and the graphic drawing are generated based on data parsed by the unit model convertor from the generated unit model;
initiating within the integrated interface, execution of an operation sequence editor;
generating through the operation sequence editor, one or more operation sequences corresponding to the unit; and
generating a unit template that includes data corresponding to the generated control logic drawing, the generated graphic drawing and the generated one or more operation sequences, wherein each of the control logic drawing, graphic drawing, and operation sequences are generated based on a format that is different from the others.

2. The method as claimed in claim 1, wherein the step of generating the control logic drawing, the graphic drawing or the one or more operation sequences includes assigning a placeholder tag to at least one unit model, or control module shape, or function block, software code segment therewithin.

3. The method as claimed in claim 2, further comprising implementing the generated engineering data within the process control system, wherein implementing the generated engineering data comprises the steps of:
retrieving the generated unit template from a library;
extracting from the retrieved unit template, engineering data comprising one or more of a control logic drawing, a graphic drawing, and one or more operation sequences;
identifying within the extracted engineering data, one or more placeholder tag names;
generating modified engineering data comprising any of a modified control logic drawing, a modified graphic drawings and one or more modified operation sequences, wherein generating the modified engineering data comprising substituting the one or more placeholder name tags with tag names corresponding to process control system components to which the extracted engineering data is intended to be applied; and
implementing the modified engineering data as control data for one or more processes executed by the process control system.

4. The method as claimed in claim 3, wherein the unit template comprises a wrapper object, and said wrapper object is identified for retrieval based on identification of one or more unit models included within the control logic drawing, graphic drawing or sequence libraries within the wrapper object.

5. The method as claimed in claim 4, comprising identifying within the extracted engineering data, one or more placeholder tag names, wherein the unit template is further identified for retrieval based on a determined correlation of said unit to one or more devices or function blocks within the process control system.

6. A system for generating engineering data for process control within a process control system, the system comprising:
a memory; and
a processor configured for:
initiating within an integrated software interface, execution of a processor implemented unit model editor;
generating within the unit model editor, a unit model that includes data corresponding to a unit represented within a piping and instrumentation diagram (P&ID);
implementing at a unit model convertor, the steps of:
generating a control logic drawing representing engineering data corresponding to the unit represented within the P&ID; and
generating a graphic drawing representing engineering data corresponding to the unit represented within the P&ID;
wherein the control logic drawing and the graphic drawing are generated based on data parsed by the unit model convertor from the generated unit model;
initiating within the integrated interface, execution of an operation sequence editor;
generating through the operation sequence editor, one or more operation sequences corresponding to the unit; and
generating a unit template that includes data corresponding to the generated control logic drawing, the generated graphic drawing and the generated one or more operation sequences, wherein each of the control logic drawing, graphic drawing, and operation sequences are generated based on a format that is different from the others.

7. The system as claimed in claim 6, configured such that generating the control logic drawing, the graphic drawing or the one or more operation sequences includes assigning a placeholder tag to at least one unit model, or control module shape, or function block, software code segment therewithin.

8. The system as claimed in claim 7, configured for implementing the generated engineering data within the process control system, wherein implementing the generated engineering data comprises:
retrieving the generated unit template from a library;
extracting from the retrieved unit template, engineering data comprising one or more of a control logic drawing, a graphic drawing, and one or more operation sequences;
identifying within the extracted engineering data, one or more placeholder tag names;
generating modified engineering data comprising any of a modified control logic drawing, a modified graphic drawings and one or more modified operation sequences, wherein generating the modified engineering data comprising substituting the one or more placeholder name tags with tag names corresponding to process control system components to which the extracted engineering data is intended to be applied; and
implementing the modified engineering data as control data for one or more processes executed by the process control system.

9. The system as claimed in claim 8, configured such that the unit template comprises a wrapper object, and said wrapper object is identified for retrieval based on identification of one or more unit models included within the control logic drawing, graphic drawing or sequence libraries within the wrapper object.

10. The system as claimed in claim 9, configured for identifying within the extracted engineering data, one or more placeholder tag names, wherein the unit template is further identified for retrieval based on a determined correlation of said unit to one or more devices or function blocks within the process control system.

11. A computer program product for generating engineering data for process control within a process control system, the computer program product comprising a non-transitory computer usable medium having a computer readable program code embodied therein, the computer readable program code comprising instructions for implementing within a processor based computing system, the steps of:
initiating within an integrated software interface, execution of a processor implemented unit model editor;
generating within the unit model editor, a unit model that includes data corresponding to a unit represented within a piping and instrumentation diagram (P&ID);
implementing at a unit model convertor, the steps of:
generating a control logic drawing representing engineering data corresponding to the unit represented within the P&ID; and
generating a graphic drawing representing engineering data corresponding to the unit represented within the P&ID;
wherein the control logic drawing and the graphic drawing are generated based on data parsed by the unit model convertor from the generated unit model;
initiating within the integrated interface, execution of an operation sequence editor;
generating through the operation sequence editor, one or more operation sequences corresponding to the unit; and
generating a unit template that includes data corresponding to the generated control logic drawing, the generated graphic drawing and the generated one or more operation sequences, wherein each of the control logic drawing, graphic drawing, and operation sequences are generated based on a format that is different from the others.

12. The computer program product as claimed in claim 11, wherein the step of generating the control logic drawing, the graphic drawing or the one or more operation sequences includes assigning a placeholder tag to at least one unit model, or control module shape, or function block, software code segment therewithin.

13. The computer program product as claimed in claim 12, further comprising instructions for implementing the generated engineering data within the process control system, wherein implementing the generated engineering data comprises the steps of:
retrieving the generated unit template from a library;
extracting from the retrieved unit template, engineering data comprising one or more of a control logic drawing, a graphic drawing, and one or more operation sequences;
identifying within the extracted engineering data, one or more placeholder tag names;
generating modified engineering data comprising any of a modified control logic drawing, a modified graphic drawings and one or more modified operation sequences, wherein generating the modified engineering data comprising substituting the one or more placeholder name tags with tag names corresponding to process control system components to which the extracted engineering data is intended to be applied; and
implementing the modified engineering data as control data for one or more processes executed by the process control system.

14. The computer program product as claimed in claim 13, wherein the unit template comprises a wrapper object, and said wrapper object is identified for retrieval based on identification of one or more units models included represented within the control logic drawing, graphic drawing or sequence libraries within the wrapper object.

15. The computer program product as claimed in claim 14, comprising instructions for identifying within the extracted engineering data, one or more placeholder tag names, wherein the unit template is further identified for retrieval based on a determined correlation of said unit to one or more devices or function blocks within the process control system.
